(19) United States
(12) Patent Application Publication
(10) Pub. No.: US 2011/0152463 A1
(43) Pub. Date: Jun. 23, 2011

(54) RESIN COMPOSITION

(76) Inventors: Hiroyuki Tanimura, Sodegaura-shi (JP); Akiko Sekino, Chiba-shi (JP)

(21) Appl. No.: 13/059,841

(22) PCT Filed: Aug. 20, 2009
(86) PCT No.: PCT/JP2009/064587

§ 371 Date: Feb. 18, 2011

(30) Foreign Application Priority Data
Aug. 21, 2008 (JP) 2008-212532

(51) Int. Cl. C08L 23/20

(52) U.S. Cl. 525/240

(57) ABSTRACT

Disclosed is a resin composition having excellent moldability and capable of giving molded articles having good appearance by slowing down the crystallization rate. The resin composition is characterized by comprising 1 to 99% by weight of the following component (A) and 99 to 1% by weight of the following component (B), wherein the total amount of the component (A) and the component (B) is 100% by weight: (A) a crystalline polypropylene-based resin; and (B) an amorphous polybutene-based resin having a weight average molecular weight of 10,000 or more, wherein neither a crystal fusion peak in which the amount of heat of crystal fusion is 1 J/g or more nor a crystallization peak in which the amount of heat of crystallization is 1 J/g or more is observed within a range of −100 to 200° C. as measured by differential scanning calorimetry (DSC).

### TECHNICAL FIELD

The present patent application claims the priority of Japanese Patent Application No. 2008-212532 (filed on Aug. 21, 2008) under the Paris Convention, the content of which is incorporated herein by reference in its entirety.

The present invention relates to a resin composition.

### BACKGROUND ART

Heretofore, in order to improve moldability or mechanical properties of polypropylene-based resins or polybutene-based resins, methods of mixing resins having different crystallinity have been found.

The crystalline polypropylene-based resin is a material having excellent moldability and thus is used for a wide variety of applications. On the other hand, the resin may cause defective molding or poor appearance of molded articles due to a fast crystallization rate in a cooling process during molding.

Patent Document 1 discloses a resin composition containing a crystalline polybutene-based resin and low crystallinity or amorphous polypropylene.

In addition, Patent Document 2 discloses a resin composition containing a crystalline olefin copolymer and an amorphous α-olefin copolymer.
Patent Document 1: JP-A-2000-8022
Patent Document 2: JP-A-2005-325194

### DISCLOSURE OF THE INVENTION

### Problems to be Solved by the Invention

In the resin composition described in Patent Document 1 or 2, the crystallization process is not considered, and therefore an effect of slowing down the crystallization rate is insufficient, thus resulting in an insufficient effect in improving the moldability of the resin composition or the appearance of the molded article.

Under such circumstances, an object of the present invention is to provide a resin composition having excellent moldability and capable of giving molded articles having good appearance by slowing down the crystallization rate.

### Means for Solving the Problems

As a result of intensive studies, the present inventors have found that the problems described above can be solved by the following means <1> and completed the present invention.

<1> A resin composition containing 1 to 99% by weight of the following component (A), and 99 to 1% by weight of the following component (B), in which the total amount of the component (A) and the component (B) is 100% by weight:

(A) a crystalline polypropylene-based resin; and

(B) an amorphous polybutene-based resin having a weight average molecular weight of 10,000 or more, wherein neither a crystal fusion peak in which the amount of heat of crystal fusion is 1 J/g or more nor a crystallization peak in which the amount of heat of crystallization is 1 J/g or more is observed within a range of −100 to 200° C. as measured by differential scanning calorimetry (DSC).

### Effects of the Invention

According to the present invention, a resin composition in which crystallization of a crystalline polypropylene-based resin is slowed down can be provided by mixing an amorphous polybutene-based resin with a crystalline polypropylene-based resin.

### BEST MODES FOR CARRYING OUT THE INVENTION

The present invention will be explained in detail below.

The resin composition of the present invention contains 1 to 99% by weight of the following component (A) and 99 to 1% by weight of the following component (B). Here, the total amount of the component (A) and the component (B) is 100% by weight.

(A) a crystalline polypropylene-based resin

(B) an amorphous polybutene-based resin having a weight average molecular weight of 10,000 or more, wherein neither a crystal fusion peak in which the amount of heat of crystal fusion is 1 J/g or more nor a crystallization peak in which the amount of heat of crystallization is 1 J/g or more is observed within a range of −100 to 200° C. as measured by differential scanning calorimetry (DSC)

The crystalline resin in the present invention refers to a polymer wherein a crystal fusion peak in which the amount of heat of crystallization is 10 J/g or more is observed within a range of −100 to 200° C. as measured by differential scanning calorimetry (DSC). The polymer wherein a crystal fusion peak in which the amount of heat of crystallization is 30 J/g or more is observed within a range of −100 to 200° C. is preferable.

The amorphous resin in the present invention refers to a polymer wherein neither a crystal fusion peak in which the amount of heat of crystal fusion is 1 J/g or more nor a crystallization peak in which the amount of heat of crystallization is 1 J/g or more is observed within a range of −100 to 200° C. as measured by differential scanning calorimetry (DSC).

The resin composition of the present invention contains 1 to 99% by weight of the component (A) and 99 to 1% by weight of the component (B), preferably 30 to 99% by weight of the component (A) and 70 to 1% by weight of the component (B), more preferably 50 to 99% by weight of the component (A) and 50 to 1% by weight of the component (B), even more preferably 50 to 97% by weight of the component (A) and 50 to 3% by weight of the component (B), still even more preferably 40 to 97% by weight of the component (A) and 60 to 3% by weight of the component (B), still even more preferably 30 to 97% by weight of the component (A) and 70 to 3% by weight of the component (B). When the contents are within the range described above, the effect of slowing down the crystallization rate of the crystalline polypropylene-based resin, obtained by mixing the amorphous polybutene-based resin with the crystalline polypropylene-based resin, is excellent.

Olefins, which can be used in the production of the crystalline propylene-based resin (component (A)), include ethylene and α-olefins having 4 to 20 carbon atoms in addition to propylene. Examples of the α-olefins having 4 to 20 carbon atoms include 1-butene, 1-pentene, 3-methyl-1-butene, 1-hexene, 4-methyl-1-pentene, and 1-octene.

Preferable crystalline polypropylene-based resins include propylene homopolymers, propylene-based random copolymers, and propylene-based block copolymers.

Examples of the propylene-based random copolymer or the propylene-based block copolymer include random copolymers or block copolymers of a propylene-ethylene copolymer, a propylene-1-butene copolymer, a propylene-ethylene-1-butene copolymer, a propylene-1-hexene copolymer, a propylene-1-octene copolymer, and a propylene-ethylene-1-hexene copolymer.

More preferable crystalline polypropylene-based resins are a propylene homopolymer, a propylene-ethylene copolymer, a propylene-1-butene copolymer, and a propylene-ethylene-1-butene copolymer.

These polymers may be used alone or as a mixture of at least two kinds thereof.

The crystalline polypropylene-based resin contains monomer units derived from propylene in an amount of more than 50% by mole and 100% by mole or less, in which the total content of the structural units derived from the monomers contained in the crystalline polypropylene-based resin (component (A)) is 100% by mole.

The crystalline polypropylene-based resin contains the monomer units derived from propylene in an amount of preferably 80 to 100% by mole, more preferably 90 to 100% by mole, even more preferably 100% by mole, that is, the crystalline polypropylene-based resin is even more preferably a polypropylene resin. When the content is within the range described above, the effect of slowing down the crystallization rate, when the amorphous polybutene-based resin is added, is excellent.

The crystalline polypropylene-based resin (component (A)) has a weight average molecular weight (Mw), as measured by gel permeation chromatography (GPC), of preferably 10,000 to 1,000,000, more preferably 50,000 to 1,000,000, even more preferably 100,000 to 500,000 in terms of the processability.

The molecular weight distribution (Mw/Mn) of the crystalline polypropylene-based resin (component (A)) is not particularly limited, but it is preferably from 1 to 4 in terms of the moldability.

As a method for producing the crystalline propylene-based resin (component (A)), a method of homopolymerizing propylene, or copolymerizing propylene and an α-olefin and/or ethylene using, for example, a Ziegler-Natta catalyst, a catalyst containing a compound of a transition metal of any one of Groups 4 to 6 of the periodic table of elements or a metallocene catalyst may be exemplified.

Examples of the Ziegler-Natta catalyst include catalysts in which a solid transition metal component containing titanium is combined with an organic metal component; and examples of the metallocene catalyst include catalysts containing a compound of a transition metal of any one of Groups 4 to 6 of the periodic table of elements having at least one cyclopentadiene-type anion skeleton.

Examples of the polymerization processes include a slurry polymerization process, a gas phase polymerization process, a bulk polymerization process, and a solution polymerization process. These polymerization processes may be used as a one-stage polymerization process in which only one process among those described above is used, or as a multi-stage polymerization process in which a combination of the processes described above is used.

Alternatively, commercially available propylene-based polymers that correspond to the crystalline propylene-based resin (component (A)) which can be used in the present invention may be used.

Olefins, which can be used in the production of the amorphous polybutene-based resin (component (B)), include ethylene, propylene, and α-olefins having 5 to 20 carbon atoms in addition to 1-butene. Examples of the α-olefins having 5 to 20 carbon atoms include 1-pentene, 3-methyl-1-butene, 1-hexene, 4-methyl-1-pentene, and 1-octene. Preferable olefins which can be used other than 1-butene are ethylene and propylene.

The amorphous polybutene-based resin (component (B)) contains monomer units derived from 1-butene in an amount of more than 50% by mole and 100% by mole or less, preferably 60 to 100% by mole, more preferably 80 to 100% by mole, even more preferably 90% by mole or more and less than 100% by mole, in which the total content of the structural units derived from the monomers contained in the amorphous polybutene resin (component (B)) is 100% by mole. When the content is within the range described above, the effect of slowing down the crystallization rate of the crystalline polypropylene-based resin, obtained by mixing the amorphous polybutene-based resin with the crystalline polypropylene-based resin, is excellent.

The amorphous polybutene-based resin may contain structural units derived from a monomer other than ethylene, propylene and α-olefins having 4 to 20 carbon atoms.

Examples of the monomer other than propylene and α-olefins having 4 to 20 carbon atoms include polyene compounds, cyclic olefins, and vinyl aromatic compounds. When the structural units derived from the monomers other than propylene and α-olefins having 4 to 20 carbon atoms are contained, their content is preferably less than 50% by mole, in which the total content of the structural units derived from the monomers contained in the amorphous polybutene-based polymer (component (B)) is 100% by mole.

The amorphous polybutene-based resin (component (B)) has a weight average molecular weight (Mw), as measured by gel permeation chromatography (GPC), of preferably 10,000 or more, more preferably 100,000 to 1,000,000, even more preferably 200,000 to 1,000,000, still even more preferably 200,000 to 800,000. When the weight average molecular weight of the component (B) is less than 10,000, the effect of slowing down the crystallization rate of the crystalline polypropylene-based resin, obtained by mixing the amorphous polybutene-based resin with the crystalline polypropylene-based resin, is poor; whereas when it is more than 1,000,000, the miscibility with the crystalline polypropylene-based polymer declines.

In the resin composition of the present invention, the amorphous polybutene-based resin (component (B)) preferably has a larger weight average molecular weight than that of the crystalline propylene-based resin (component (A)). The embodiment described above is excellent in the effect of slowing down the crystallization rate of the crystalline polypropylene-based resin obtained by mixing the amorphous polybutene-based resin with the crystalline polypropylene-based resin.

The amorphous polybutene-based resin (component (B)) has a molecular weight distribution (Mw/Mn) of preferably 1 to 4, more preferably 1 to 2.5, even more preferably 1 to 1.8. When the molecular weight distribution is within the range described above, the effect of slowing down the crystallization rate of the crystalline polypropylene-based resin, obtained by mixing the amorphous polybutene-based resin with the crystalline polypropylene-based resin, is excellent. The “Mn” is a number average molecular weight.

A resin which is polymerized in the presence of a catalyst containing, as a catalyst component, a transition metal complex represented by the following formula (1) is preferable as the component (B) which can be used in the resin composition of the present invention.

When the transition metal complex represented by the formula (1) is used as the catalyst component, an amorphous polybutene-based resin having a high weight average molecular weight can be easily produced.

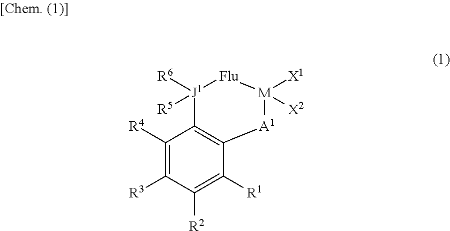

In the formula, M is a transition metal atom of Group 4 of the periodic table of elements; A¹ is an atom of Group 16 of the periodic table of elements; J¹ is an atom of Group 14 of the periodic table of elements; Flu is a group having a fluorenyl-type anion skeleton; X¹ and X² are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R¹, R², R³ and R⁴ are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R⁵ and R⁶ are each independently a hydrogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom or an amino group disubstituted by hydrocarbons each having 2 to 20 carbon atoms; and adjacent groups of R¹, R², R³, R⁴, R⁵ and R⁶ may be optionally bonded to form a ring.

In the transition metal complex represented by the formula (1) (hereinafter referred to as a “transition metal complex (1)”), the transition metal atom represented by M is a transition metal atom of Group 4 of the periodic table of elements (IUPAC Inorganic Chemical Nomenclature, Revised Edition, 1989). Examples thereof include a titanium atom, a zirconium atom, and a hafnium atom; and a titanium atom may be preferably exemplified.

Examples of the atom of Group 16 of the periodic table of elements in A¹ include an oxygen atom, a sulfur atom, and a selenium atom; and an oxygen atom may be preferably exemplified.

Examples of the atom of Group 14 of the periodic table of elements in J¹ include a carbon atom, a silicon atom, and a germanium atom; and a silicon atom may be preferably exemplified.

Examples of the group having a fluorenyl-type anion skeleton in the substituent Flu include a fluorenyl group, a 1-methylfluorenyl group, a 2-methylfluorenyl group, a 3-methylfluorenyl group, a 4-methylfluorenyl group, a 1-t-butylfluorenyl group, a 2-t-butylfluorenyl group, a 3-t-butylfluorenyl group, a 4-t-butylfluorenyl group, a 1-phenylfluorenyl group, a 2-phenylfluorenyl group, a 3-phenylfluorenyl group, a 4-phenylfluorenyl group, a 1,8-dimethylfluorenyl group, a 2,7-dimethylfluorenyl group, a 3,6-dimethylfluorenyl group, a 4,5-dimethylfluorenyl group, a 1,8-di-t-butylfluorenyl group, a 2,7-di-t-butylfluorenyl group, a 3,6-di-t-butylfluorenyl group, a 4,5-di-t-butylfluorenyl group, a 1,8-diphenylfluorenyl group, a 2,7-diphenylfluorenyl group, a 3,6-diphenylfluorenyl group, and a 4,5-diphenylfluorenyl group. Of these, a fluorenyl group and a 2,7-diphenylfluorenyl group are preferable. The hydrogen atom on the carbon atom of the substituent Flu may be substituted by a halogen atom or an alkyl group having 1 to 20 carbon atoms which may be substituted by a halogen atom. Examples of the halogen atom include a fluorine atom, a chlorine atom, a bromine atom, and an iodine atom. Examples of the alkyl group having 1 to 20 carbon atoms which may be substituted by a halogen atom include a methyl group, an ethyl group, an n-propyl group, an isopropyl group, an n-butyl group, a sec-butyl group, a tert-butyl group, an n-pentyl group, a neopentyl group, an amyl group, an n-hexyl group, an n-octyl group, an n-decyl group, an n-dodecyl group, an n-pentadecyl group, and an n-eicosyl group.

Examples of the halogen atom in the substituents X¹, X², R¹, R², R³ and R⁴ include a fluorine atom, a chlorine atom, a bromine atom, and an iodine atom; and a chlorine atom may be preferably exemplified.

Examples of the alkyl group having 1 to 20 carbon atoms in the substituents X¹, X², R¹, R², R³, R⁴, R⁶ and R⁶ include a methyl group, an ethyl group, an n-propyl group, an isopropyl group, an n-butyl group, a sec-butyl group, a tert-butyl group, an n-pentyl group, a neopentyl group, an amyl group, an n-hexyl group, an n-octyl group, an n-decyl group, an n-dodecyl group, an n-pentadecyl group, and an n-eicosyl group; and a methyl group, an ethyl group, an isopropyl group, a tert-butyl group and an amyl group may be preferably exemplified.

Any hydrogen atom on these alkyl groups may be substituted by a halogen atom such as a fluorine atom, a chlorine atom, a bromine atom or an iodine atom. Examples of the alkyl group having 1 to 20 carbon atoms which is substituted by a halogen atom include a fluoromethyl group, a difluoromethyl group, a trifluoromethyl group, a chloromethyl group, a dichloromethyl group, a trichloromethyl group, a bromomethyl group, a dibromomethyl group, a tribromomethyl group, an iodomethyl group, a diiodomethyl group, a triiodomethyl group, a fluoroethyl group, a difluoroethyl group, a trifluoroethyl group, a tetrafluoroethyl group, a pentafluoroethyl group, a chloroethyl group, a dichloroethyl group, a trichloroethyl group, a tetrachloroethyl group, a pentachloroethyl group, a bromoethyl group, a dibromoethyl group, a tribromoethyl group, a tetrabromoethyl group, a pentabromoethyl group, a perfluoropropyl group, a perfluorobutyl group, a perfluoropentyl group, a perfluorohexyl group, a perfluorooctyl group, a perfluorododecyl group, a perfluoropentadecyl group, a perfluoroeicosyl group, a perchloropropyl group, a perchlorobutyl group, a perchloropentyl group, a perchlorohexyl group, a perchlorooctyl group, a perchlorododecyl group, a perchloropentadecyl group, a perchloroeicosyl group, a perbromopropyl group, a perbromobutyl group, a perbromopentyl group, a perbromohexyl group, a perbromooctyl group, a perbromododecyl group, a perbromopentadecyl group, and a perbromoeicosyl group.

Examples of the aralkyl group having 7 to 20 carbon atoms in the substituents X¹, X², R¹, R², R³, R⁴, R⁶ and R⁶ include a benzyl group, a (2-methylphenyl)methyl group, a (3-methylphenyl)methyl group, a (4-methylphenyl)methyl group, a (2,3-dimethylphenyl)methyl group, a (2,4-dimethylphenyl)methyl group, a (2,5-dimethylphenyl)methyl group, a (2,6-dimethylphenyl)methyl group, a (3,4-dimethylphenyl)methyl group, a (4,6-dimethylphenyl)methyl group, a (2,3,4-trimethylphenyl)methyl group, a (2,3,5-trimethylphenyl)methyl group, a (2,3,6-trimethylphenyl)methyl group, a (3,4,5-trimethylphenyl)methyl group, a (2,4,6-trimethylphenyl)methyl group, a (2,3,4,5-tetramethylphenyl)methyl group, a (2,3,4,6-tetramethylphenyl)methyl group, a (2,3,5,6-tetramethylphenyl)methyl group, a (pentamethylphenyl)methyl group, an (ethylphenyl)methyl group, an (n-propylphenyl)methyl group, an (isopropylphenyl)methyl group, an (n-butylphenyl)methyl group, a (sec-butylphenyl)methyl group, a (tert-butylphenyl)methyl group, an (n-pentylphenyl)methyl group, a (neopentylphenyl)methyl group, an (n-hexylphenyl)methyl group, an (n-octylphenyl)methyl group, an (n-decylphenyl)methyl group, an (n-decylphenyl)methyl group, an (n-tetradecylphenyl)methyl group, a naphthylmethyl group, and an anthracenylmethyl group; and a benzyl group may be preferably exemplified.

Any hydrogen atom on these aralkyl groups may be substituted by a halogen atom such as a fluorine atom, a chlorine atom, a bromine atom or an iodine atom.

Examples of the aryl group having 6 to 20 carbon atoms in the substituents X¹, X², R¹, R², R³, R⁴, R⁶ and R⁶ include a phenyl group, a 2-tolyl group, a 3-tolyl group, a 4-tolyl group, a 2,3-xylyl group, a 2,4-xylyl group, a 2,5-xylyl group, a 2,6-xylyl group, a 3,4-xylyl group, a 3,5-xylyl group, a 2,3,4-trimethylphenyl group, a 2,3,5-trimethylphenyl group, a 2,3,6-trimethylphenyl group, a 2,4,6-trimethylphenyl group, a 3,4,5-trimethylphenyl group, a 2,3,4,5-tetramethylphenyl group, a 2,3,4,6-tetramethylphenyl group, a 2,3,5,6-tetramethylphenyl group, a pentamethylphenyl group, an ethylphenyl group, an n-propylphenyl group, an isopropylphenyl group, an n-butylphenyl group, a sec-butylphenyl group, a tert-butylphenyl group, an n-pentylphenyl group, a neopentylphenyl group, an n-hexylphenyl group, an n-octylphenyl group, an n-decylphenyl group, an n-dodecylphenyl group, an n-tetradecylphenyl group, a naphthyl group, and an anthracenyl group; and a phenyl group may be preferably exemplified.

Any hydrogen atom on these aryl groups may be substituted by a halogen atom such as a fluorine atom, a chlorine atom, a bromine atom or an iodine atom.

The hydrocarbon-substituted silyl group in the substituents R¹, R², R³, R⁴, R⁵ and R⁶ is a silyl group which is substituted by a hydrocarbon group having 1 to 20 carbon atoms. Examples of the hydrocarbon group include alkyl groups having 1 to 10 carbon atoms such as a methyl group, an ethyl group, an n-propyl group, an isopropyl group, an n-butyl group, a sec-butyl group, a tert-butyl group, an isobutyl group, an n-pentyl group, an n-hexyl group and a cyclohexyl group; and aryl groups such as a phenyl group. Examples of the silyl group which is substituted by a hydrocarbon having 1 to 20 carbon atoms include silyl groups which are monosubstituted by a hydrocarbon having 1 to 20 carbon atoms, such as a methylsilyl group, an ethylsilyl group and a phenylsilyl group; silyl groups which are disubstituted by hydrocarbons each having 2 to 20 carbon atoms, such as a dimethylsilyl group, a diethylsilyl group and a diphenylsilyl group; and silyl groups which are trisubstituted by hydrocarbons each having 3 to 20 carbon atoms, such as a trimethylsilyl group, a triethylsilyl group, a tri-n-propylsilyl group, a triisopropylsilyl group, a tri-n-butylsilyl group, a tri-sec-butylsilyl group, a tri-tert-butylsilyl group, a tri-isobutylsilyl group, a tert-butyl-dimethylsilyl group, a tri-n-pentylsilyl group, a tri-n-hexylsilyl group, a tricyclohexylsilyl group, and a triphenylsilyl group; and a trimethylsilyl group, a tert-butyldimethylsilyl group and a triphenylsilyl group may be preferably exemplified.

Any hydrogen atom on the hydrocarbon groups in these hydrocarbon-substituted silyl groups may be substituted by a halogen atom such as a fluorine atom, a chlorine atom, a bromine atom or an iodine atom.

Examples of the alkoxy group having 1 to 20 carbon atoms in the substituents X¹, X², R¹, R², R³, R⁴, R⁵ and R⁶ include a methoxy group, an ethoxy group, an n-propoxy group, an isopropoxy group, an n-butoxy group, a sec-butoxy group, a tert-butoxy group, an n-pentoxy group, a neopentoxy group, an n-hexoxy group, an n-octoxy group, an n-dodesoxy group, an n-pentadesoxy group, and an n-icosoxy group; and a methoxy group, an ethoxy group and a tert-butoxy group may be preferably exemplified.

Any hydrogen atom on these alkoxy groups may be substituted by a halogen atom such as a fluorine atom, a chlorine atom, a bromine atom or an iodine atom.

Examples of the aralkyloxy group having 7 to 20 carbon atoms in the substituents X¹, X², R¹, R², R³, R⁴, R⁵ and R⁶ include a benzyloxy group, a (2-methylphenyl)methoxy group, a (3-methylphenyl)methoxy group, a (4-methylphenyl)methoxy group, a (2,3-dimethylphenyl)methoxy group, a (2,4-dimethylphenyl)methoxy group, a (2,5-dimethylphenyl)methoxy group, a (2,6-dimethylphenyl)methoxy group, a (3,4-dimethylphenyl)methoxy group, a (3,5-dimethylphenyl)methoxy group, a (2,3,4-trimethylphenyl)methoxy group, a (2,3,5-trimethylphenyl)methoxy group, a (2,3,6-trimethylphenyl)methoxy group, a (2,4,5-trimethylphenyl)methoxy group, a (2,4,6-trimethylphenyl)methoxy group, a (3,4,5-trimethylphenyl)methoxy group, a (2,3,4,5-tetramethylphenyl)methoxy group, a (2,3,4,6-tetramethylphenyl)methoxy group, a (2,3,5,6-tetramethylphenyl)methoxy group, a (pentamethylphenyl)methoxy group, an (ethylphenyl)methoxy group, an (n-propylphenyl)methoxy group, an (isopropylphenyl)methoxy group, an (n-butylphenyl)methoxy group, a (sec-butylphenyl)methoxy group, a (tert-butylphenyl)methoxy group, an (n-hexylphenyl)methoxy group, an (n-octylphenyl)methoxy group, an (n-decylphenyl)methoxy group, an (n-tetradecylphenyl)methoxy group, a naphthylmethoxy group, and an anthracenylmethoxy group; and a benzyloxy group may be preferably exemplified.

Any hydrogen atom on these aralkyloxy groups may be substituted by a halogen atom such as a fluorine atom, a chlorine atom, a bromine atom or an iodine atom.

Examples of the aryloxy group in the substituents X¹, X², R¹, R², R³, R⁴, R⁵ and R⁶ include aryloxy groups having 6 to 20 carbon atoms such as a phenoxy group, a 2-methylphenoxy group, a 3-methylphenoxy group, a 4-methylphenoxy group, a 2,3-dimethylphenoxy group, a 2,4-dimethylphenoxy group, a 2,5-dimethylphenoxy group, a 2,6-dimethylphenoxy group, a 3,4-dimethylphenoxy group, a 3,5-dimethylphenoxy group, a 2,3,4-trimethylphenoxy group, a 2,3,5-trimethylphenoxy group, a 2,3,6-trimethylphenoxy group, a 2,4,5-trimethylphenoxy group, a 2,4,6-trimethylphenoxy group, a 3,4,5-trimethylphenoxy group, a 2,3,4,5-tetramethylphenoxy group, a 2,3,4,6-tetramethylphenoxy group, a 2,3,5,6-tetramethylphenoxy group, a pentamethylphenoxy group, an ethylphenoxy group, an n-propylphenoxy group, an isopropylphenoxy group, an n-butylphenoxy group, a sec-butylphenoxy group, a tert-butylphenoxy group, an n-hexylphenoxy group, an n-octylphenoxy group, an n-decylphenoxy group, an n-tetradecylphenoxy group, a naphthoxy group and an anthracenoxy group.

Any hydrogen atom on these aryloxy groups may be substituted by a halogen atom such as a fluorine atom, a chlorine atom, a bromine atom or an iodine atom.

The amino group disubstituted by hydrocarbons each having 2 to 20 carbon atoms in the substituents X¹, X², R¹, R², R³, R⁴, R⁵ and R⁶ is an amino group which is substituted by two hydrocarbon groups. Examples of the hydrocarbon group include alkyl groups having 1 to 20 carbon atoms such as a methyl group, an ethyl group, an n-propyl group, an isopropyl group, an n-butyl group, a sec-butyl group, a tert-butyl group, an isobutyl group, an n-pentyl group, an n-hexyl group, and a cyclohexyl group; and aryl groups such as a phenyl group. Examples of the amino group which is disubstituted by hydrocarbons each having 1 to 20 carbon atoms include a dimethylamino group, a diethylamino group, a di-n-propylamino group, a diisopropylamino group, a di-n-butylamino group, a di-sec-butylamino group, a di-tert-butylamino group, a di-isobutylamino group, a tert-butylisopropylamino group, a di-n-hexylamino group, a di-n-octylamino group, a di-n-decylamino group, a diphenylamino group, a bistrimethylsilylamino group, and a bis-tert-butyldimethylsilylamino group; and a dimethylamino group and a diethylamino group may be preferably exemplified.

The adjacent groups of the substituents R¹, R², R³, R⁴, R⁵ and R⁶ may be optionally bonded to each other to form a ring.

X¹ and X², each independently, are preferably a halogen atom, an alkyl group, an aralkyl group, or the like, more preferably a halogen atom. It is preferable that X¹ and X² be the same groups.

Preferable examples of R¹ include an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, and a silyl group substituted by a hydrocarbon having 1 to 20 carbon atoms which may be substituted by a halogen atom.

Examples of the transition metal complex (1) include the following compounds: methylene(fluorenyl)(3,5-dimethyl-2-phenoxy)titanium dichloride, methylene(fluorenyl)(3-tert-butyl-2-phenoxy)titanium dichloride, methylene(fluorenyl)(3-tert-butyl-5-methyl-2-phenoxy)titanium dichloride, methylene(fluorenyl)(3-phenyl-2-phenoxy)titanium dichloride, methylene(fluorenyl)(3-tert-butyldimethylsilyl-5-methyl-2-phenoxy)titanium dichloride, methylene(fluorenyl)(3-trimethylsilyl-5-methyl-2-phenoxy)titanium dichloride, methylene(fluorenyl)(3-tert-butyl-5-methoxy-2-phenoxy)titanium dichloride, methylene(fluorenyl)(3-tert-butyl-5-chloro-2-phenoxy)titanium dichloride, methylene(1-methylfluorenyl)(3-tert-butyl-5-methyl-2-phenoxy)titanium dichloride, methylene(2-methylfluorenyl)(3-tert-butyl-5-methyl-2-phenoxy)titanium dichloride, methylene(3-methylfluorenyl)(3-tert-butyl-5-methyl-2-phenoxy)titanium dichloride, methylene(4-methylfluorenyl)(3-tert-butyl-5-methyl-2-phenoxy)titanium dichloride, methylene(1-t-butylfluorenyl)(3-tert-butyl-5-methyl-2-phenoxy)titanium dichloride, methylene(2-t-butylfluorenyl)(3-tert-butyl-5-methyl-2-phenoxy)titanium dichloride, methylene(3-t-butylfluorenyl)(3-tert-butyl-5-methyl-2-phenoxy)titanium dichloride, methylene(4-t-butylfluorenyl)(3-tert-butyl-5-methyl-2-phenoxy)titanium dichloride, methylene(1-phenylfluorenyl)(3-tert-butyl-5-methyl-2-phenoxy)titanium dichloride, methylene(2-phenylfluorenyl)(3-tert-butyl-5-methyl-2-phenoxy)titanium dichloride, methylene(3-phenylfluorenyl)(3-tert-butyl-5-methyl-2-phenoxy)titanium dichloride, methylene(4-phenylfluorenyl)(3-tert-butyl-5-methyl-2-phenoxy)titanium dichloride, methylene(1,8-dimethylfluorenyl)(3-tert-butyl-5-methyl-2-phenoxy)titanium dichloride, methylene(2,7-dimethylfluorenyl)(3-tert-butyl-5-methyl-2-phenoxy)titanium dichloride, methylene(3,6-dimethylfluorenyl)(3-tert-butyl-5-methyl-2-phenoxy)titanium dichloride, methylene(4,5-dimethylfluorenyl)(3-tert-butyl-5-methyl-2-phenoxy)titanium dichloride, methylene(1,8-di-t-butylfluorenyl)(3-tert-butyl-5-methyl-2-phenoxy)titanium dichloride, methylene(2,7-di-t-butylfluorenyl)(3-tert-butyl-5-methyl-2-phenoxy)titanium dichloride, methylene(3,6-di-t-butylfluorenyl) (3-tert-butyl-5-methyl-2-phenoxy)titanium dichloride, methylene(4,5-di-t-butylfluorenyl)(3-tert-butyl-5-methyl-2-phenoxy)titanium dichloride, methylene(1,8-diphenylfluorenyl)(3-tert-butyl-5-methyl-2-phenoxy)titanium dichloride, methylene(2,7-diphenylfluorenyl)(3-tert-butyl-5-methyl-2-phenoxy)titanium dichloride, methylene(3,6-diphenylfluorenyl)(3-tert-butyl-5-methyl-2-phenoxy)titanium dichloride, and methylene(4,5-diphenylfluorenyl)(3-tert-butyl-5-methyl-2-phenoxy)titanium dichloride;

isopropylidene(fluorenyl)(3,5-dimethyl-2-phenoxy)titanium dichloride, isopropylidene(fluorenyl)(3-tert-butyl-2-phenoxy)titanium dichloride, isopropylidene(fluorenyl)(3-tert-butyl-5-methyl-2-phenoxy)titanium dichloride, isopropylidene(fluorenyl)(3-phenyl-2-phenoxy)titanium dichloride, isopropylidene(fluorenyl)(3-tert-butyldimethylsilyl-5-methyl-2-phenoxy)tita nium dichloride, isopropylidene(fluorenyl)(3-trimethylsilyl-5-methyl-2-phenoxy)titanium dichloride, isopropylidene(fluorenyl)(3-tert-butyl-5-methoxy-2-phenoxy)titanium dichloride, isopropylidene(fluorenyl)(3-tert-butyl-5-chloro-2-phenoxy)titanium dichloride, isopropylidene(1-methylfluorenyl)(3-tert-butyl-5-methyl-2-phenoxy)titanium dichloride, isopropylidene(2-methylfluorenyl)(3-tert-butyl-5-methyl-2-phenoxy)titanium dichloride, isopropylidene(3-methylfluorenyl)(3-tert-butyl-5-methyl-2-phenoxy)titanium dichloride, isopropylidene(4-methylfluorenyl)(3-tert-butyl-5-methyl-2-phenoxy)titanium dichloride, isopropylidene(1-t-butylfluorenyl)(3-tert-butyl-5-methyl-2-phenoxy)titanium dichloride, isopropylidene(2-t-butylfluorenyl)(3-tert-butyl-5-methyl-2-phenoxy)titanium dichloride, isopropylidene(3-t-butylfluorenyl)(3-tert-butyl-5-methyl-2-phenoxy)titanium dichloride, isopropylidene(4-t-butylfluorenyl)(3-tert-butyl-5-methyl-2-phenoxy)titanium dichloride, isopropylidene(1-phenylfluorenyl)(3-tert-butyl-5-methyl-2-phenoxy)titanium dichloride, isopropylidene(2-phenylfluorenyl)(3-tert-butyl-5-methyl-2-phenoxy)titanium dichloride, isopropylidene(3-phenylfluorenyl)(3-tert-butyl-5-methyl-2-phenoxy)titanium dichloride, isopropylidene (4-phenylfluorenyl)(3-tert-butyl-5-methyl-2-phenoxy)titanium dichloride, isopropylidene(1,8-dimethylfluorenyl)(3-tert-butyl-5-methyl-2-phenoxy)titan ium dichloride, isopropylidene (2,7-dimethylfluorenyl)(3-tert-butyl-5-methyl-2-phenoxy)titan ium dichloride, isopropylidene(3,6-dimethylfluorenyl)(3-tert-butyl-5-methyl-2-phenoxy)titan ium dichloride, isopropylidene (4,5-dimethylfluorenyl)(3-tert-b utyl-5-methyl-2-phenoxy)titan ium dichloride, isopropylidene(1,8-di-t-butylfluorenyl)(3-tert-butyl-5-methyl-2-phenoxy)tita nium dichloride, isopropylidene (2,7-di-t-butylfluorenyl)(3-tert-butyl-5-methyl-2-phenoxy)tita nium dichloride, isopropylidene(3,6-di-t-butylfluorenyl) (3-tert-butyl-5-methyl-2-phenoxy)tita nium dichloride, isopropylidene (4,5-di-t-butylfluorenyl)(3-tert-butyl-5-methyl-2-phenoxy)tita nium dichloride, isopropylidene (1,8-diphenylfluorenyl)(3-tert-butyl-5-methyl-2-phenoxy)titan ium dichloride, isopropylidene(2,7-diphenylfluorenyl)(3-tert-butyl-5-methyl-2-phenoxy)titan ium dichloride, isopropylidene(3,6-diphenylfluorenyl) (3-tert-butyl-5-methyl-2-phenoxy)titan ium dichloride, and isopropylidene(4,5-diphenylfluorenyl)(3-tert-butyl-5-methyl-2-phenoxy)titanium dichloride;

diphenylmethylene(fluorenyl)(3,5-dimethyl-2-phenoxy)titanium dichloride, diphenylmethylene(fluorenyl)(3-tert-butyl-2-phenoxy)titanium dichloride, diphenylmethylene(fluorenyl)(3-tert-butyl-5-methyl-2-phenoxy)titanium dichloride, diphenylmethylene(fluorenyl)(3-phenyl-2-phenoxy)titanium dichloride, diphenylmethylene(fluorenyl)(3-tert-butyldimethylsilyl-5-methyl-2-phenoxy) titanium dichloride, diphenylmethylene(fluorenyl)(3-trimethylsilyl-5-methyl-2-phenoxy)titanium dichloride, diphenylmethylene(fluorenyl)(3-tert-butyl-5-methoxy-2-phenoxy)titanium dichloride, diphenylmethylene(fluorenyl)(3-tert-butyl-5-chloro-2-phenoxy)titanium dichloride, diphenylmethylene(1-methylfluorenyl)(3-tert-butyl-5-methyl-2-phenoxy)tita nium dichloride, diphenylmethylene (2-methylfluorenyl)(3-tert-butyl-5-methyl-2-phenoxy)tita nium dichloride, diphenylmethylene(3-methylfluorenyl)(3-tert-butyl-5-methyl-2-phenoxy)tita nium dichloride, diphenylmethylene (4-methylfluorenyl)(3-tert-butyl-5-methyl-2-phenoxy)tita nium dichloride, diphenylmethylene(1-t-butylfluorenyl)(3-tert-butyl-5-methyl-2-phenoxy)tita nium dichloride, diphenylmethylene(2-t-butylfluorenyl)(3-tert-butyl-5-methyl-2-phenoxy)tita nium dichloride, diphenylmethylene(3-t-butylfluorenyl)(3-tert-butyl-5-methyl-2-phenoxy)tita nium dichloride, diphenylmethylene(4-t-butylfluorenyl)(3-tert-butyl-5-methyl-2-phenoxy)tita nium dichloride, diphenylmethylene(1-phenylfluorenyl) (3-tert-butyl-5-methyl-2-phenoxy)tita nium dichloride, diphenylmethylene(2-phenylfluorenyl)(3-tert-butyl-5-methyl-2-phenoxy)tita nium dichloride, diphenylmethylene(3-phenylfluorenyl)(3-tert-butyl-5-methyl-2-phenoxy)tita nium dichloride, diphenylmethylene(4-phenylfluorenyl)(3-tert-butyl-5-methyl-2-phenoxy)tita nium dichloride, diphenylmethylene(1,8-dimethylfluorenyl)(3-tert-butyl-5-methyl-2-phenoxy) titanium dichloride, diphenylmethylene(2,7-dimethylfluorenyl)(3-tert-butyl-5-methyl-2-phenoxy) titanium dichloride, diphenylmethylene(3,6-dimethylfluorenyl)(3-tert-butyl-5-methyl-2-phenoxy) titanium dichloride, diphenylmethylene(4,5-dimethylfluorenyl)(3-tert-butyl-5-methyl-2-phenoxy) titanium dichloride, diphenylmethylene(1,8-di-t-butylfluorenyl)(3-tert-butyl-5-methyl-2-phenoxy) titanium dichloride, diphenylmethylene(2,7-di-t-butylfluorenyl)(3-tert-butyl-5-methyl-2-phenoxy) titanium dichloride, diphenylmethylene(3,6-di-t-butylfluorenyl)(3-tert-butyl-5-methyl-2-phenoxy) titanium dichloride, diphenylmethylene(4,5-di-t-butylfluorenyl)(3-tert-butyl-5-methyl-2-phenoxy) titanium dichloride, diphenylmethylene(1,8-diphenylfluorenyl)(3-tert-butyl-5-methyl-2-phenoxy) titanium dichloride, diphenylmethylene (2,7-diphenylfluorenyl)(3-tert-butyl-5-methyl-2-phenoxy) titanium dichloride, diphenylmethylene(3,6-diphenylfluorenyl)(3-tert-butyl-5-methyl-2-phenoxy) titanium dichloride, diphenylmethylene(4,5-diphenylfluorenyl)(3-tert-butyl-5-methyl-2-phenoxy) titanium dichloride, and the like, and compounds in which titanium in the above-mentioned compounds is replaced by zirconium or hafnium, compounds in which the chloride is replaced by a bromide, an iodide, dimethylamide, diethylamide, n-butoxide or isopropoxide, compounds in which 3,5-dimethyl-2-phenoxy is replaced by 2-phenoxy, 3-methyl-2-phenoxy, 3,5-di-tert-butyl-2-phenoxy, 3-phenyl-5-methyl-2-phenoxy, 3-tert-butyldimethylsilyl-2-phenoxy, or 3-trimethylsilyl-2-phenoxyl, and compounds in which methylene is replaced by diethylmethylene; and dimethylsilyl(fluorenyl)(2-phenoxy)titanium dichloride, dimethylsilyl(fluorenyl(3-methyl-2-phenoxy)titanium dichloride, dimethylsilyl(fluorenyl)(3,5-dimethyl-2-phenoxy)titanium dichloride, dimethylsilyl(fluorenyl)(3-tert-butyl-2-phenoxy)titanium dichloride, dimethylsilyl(fluorenyl)(3-tert-butyl-5-methyl-2-phenoxy)titanium dichloride, dimethylsilyl(fluorenyl)(3,5-di-tert-butyl-2-phenoxy)titanium dichloride, dimethylsilyl(fluorenyl)(5-methyl-3-phenyl-2-phenoxy)titanium dichloride, dimethylsilyl(fluorenyl)(3-tert-butyldimethylsilyl-5-methyl-2-phenoxy)titani um dichloride, dimethylsilyl(fluorenyl)(5-methyl-3-trimethylsilyl-2-phenoxy)titanium dichloride, dimethylsilyl(fluorenyl)(3-tert-butyl-5-methoxy-2-phenoxy)titanium dichloride, dimethylsilyl(fluorenyl)(3-tert-butyl-5-chloro-2-phenoxy)titanium dichloride, dimethylsilyl(fluorenyl)(3,5-diamyl-2-phenoxy)titanium dichloride, and the like, and compounds in which (fluorenyl) in the above-mentioned compounds is replaced by (1-methylfluorenyl), (2-methylfluorenyl, (3-methylfluorenyl), (4-methylfluorenyl), (1-t-butylfluorenyl), (2-t-butylfluorenyl), (3-t-butylfluorenyl), (4-t-butylfluorenyl), (1-phenylfluorenyl, (2-phenylfluorenyl), (3-phenylfluorenyl), (4-phenylfluorenyl), (1,8-dimethylfluorenyl), (2,7-dimethylfluorenyl), (3,6-dimethylfluorenyl), (4,5-dimethylfluorenyl), (1,8-di-t-butylfluorenyl), (2,7-di-t-butylfluorenyl), (3,6-di-t-butylfluorenyl), (4,5-di-t-butylfluorenyl), (1,8-diphenylfluorenyl), (2,7-diphenylfluorenyl), 2,7-di(2-methylphenyl)fluorenyl, 2,7-di(3-methylphenyl)fluorenyl, 2,7-di(4-methylphenyl)fluorenyl, 2,7-di(2-ethylphenyl)fluorenyl, 2,7-di(3-ethylphenyl)fluorenyl, 2,7-di(4-ethylphenyl)fluorenyl, 2,7-di(2-n-propylphenyl)fluorenyl, 2,7-di(3-n-propylphenyl)fluorenyl, 2,7-di(4-n-propylphenyl)fluorenyl, 2,7-di(2-n-butylphenyl)fluorenyl, 2,7-di(3-n-butylphenyl)fluorenyl, 2,7-di(4-n-butylphenyl)fluorenyl, 2,7-di(2-sec-butylphenyl)fluorenyl, 2,7-di(3-sec-butylphenyl)fluorenyl, 2,7-di(4-sec-butylphenyl)fluorenyl, 2,7-di(2-tert-butylphenyl)fluorenyl, 2,7-di(3-tert-butylphenyl)fluorenyl, 2,7-di(4-tert-butylphenyl)fluorenyl, (3,6-diphenylfluorenyl), or (4,5-diphenylfluorenyl), compounds in which 2-phenoxy is replaced by 3-phenyl-2-phenoxy, 3-trimethylsilyl-2-phenoxy, or 3-tert-butyldimethylsilyl-2-phenoxy, compounds in which dimethylsilyl is replaced by diethylsilyl, diphenylsilyl or dimethoxysilyl, compounds in which titanium is replaced by zirconium or hafnium, compounds in which the chloride is replaced by a bromide, an iodide, dimethylamide, diethylamide, n-butoxide or isopropoxide.

The transition metal complex (1) described above can be synthesized in accordance with the method described in JP-A-9-87313 or JP-A-2007-217284.

When the catalyst containing the transition metal complex represented by the formula (1) as the catalyst component is used, the following compound (B) may be used as a co-catalyst, or the compound (B) and a compound (C) may be used as additional catalyst components.

(B): Any one or a mixture of two or three kinds of the following compounds (B1) to (B3)

(B1): An organoaluminum compound represented by the formula: E¹ₐAlZ₃₋ₐ

(B2): A cyclic aluminoxane having a structure represented by the formula: {—Al(E³)-O—}_{b}

(B3): A linear aluminoxane having a structure represented by the formula: E³{-Al(E³)-O—}^{c}AlE³₂

(In the formulae, E¹ to E³ are hydrocarbon groups having 1 to 8 carbon atoms, and all E¹s, all E²s, and all E³s may be the same or different; Z is a hydrogen atom or a halogen atom, and all Zs may be the same or different; a is a numeral of 0<a≦3; b is an integer of 2 or more; and c is an integer of 1 or more.)

(C): Any one of the following compounds (C1) to (C3)

(C1): A boron compound represented by the formula: BQ¹Q²Q³

(C2): A boron compound represented by the formula: Z⁺ (3Q¹Q²Q³Q⁴)⁻

(C3): A boron compound represented by the formula:

(L−H)+(BQ¹Q²Q³Q⁴)⁻

(In the formulae, B is a boron atom having a valence of three; Q¹ to Q⁴ are each a halogen atom, a hydrocarbon group having 1 to 20 carbon atoms, a halogenated hydrocarbon group having 1 to 20 carbon atoms, a silyl group which is substituted by a hydrocarbon having 1 to 20 carbon atoms, an alkoxy group having 1 to 20 carbon atoms, or an amino group which is disubstituted by hydrocarbons each having 2 to 20 carbon atoms, and they may be the same or different.)

Preferable examples of the compound (B) include any one and mixtures of two or three kinds of: (B1): an organoaluminum compound represented by the formula: E¹ₐAlZ₃₋ₐ; (B2): a cyclic aluminoxane having a structure represented by the formula: {—Al(E²)-O—}_{b}; and (B3): a linear aluminoxane having a structure represented by the formula: E³{-Al(E³)-O—}_{c}AlE³₂ wherein E¹, E² and E³ are each a hydrocarbon group having 1 to 8 carbon atoms, and all E¹s, all E²s and all E³s may be the same or different; Z is a hydrogen atom or a halogen atom, and all Zs may be the same or different; a is a numeral of 0<a≦3; b is an integer of 2 or more; and c is an integer of 1 or more. Publicly known aluminum compounds may be used.

Concrete examples of the organoaluminum compound (B1) represented by the formula: E¹ₐAlZ₃₋ₐ include trialkyl aluminum such as trimethyl aluminum, triethyl aluminum, tripropyl aluminum, triisobutyl aluminum, or trihexyl aluminum; dialkyl aluminum chloride such as dimethyl aluminum chloride, diethyl aluminum chloride, dipropyl aluminum chloride, diisobutyl aluminum chloride, or dihexyl aluminum chloride; alkyl aluminum dichloride such as methyl aluminum dichloride, ethyl aluminum dichloride, propyl aluminum dichloride, isobutyl aluminum dichloride, or hexyl aluminum dichloride; and dialkyl aluminum hydride such as dimethyl aluminum hydride, diethyl aluminum hydride, dipropyl aluminum hydride, diisobutyl aluminum hydride, or dihexyl aluminum hydride.

Trialkyl aluminum is preferable, and triethyl aluminum and triisobutyl aluminum are more preferable.

Concrete examples of E² and E³ in the cyclic aluminoxane (B2) having a structure represented by the formula: {—Al(E²)-O—}_{b} and the linear aluminoxane (B3) having a structure represented by the formula: E³{-Al(E³)-O-}ALE³₂, wherein b is an integer of 2 or more, and c is an integer of 1 or more, include alkyl groups such as a methyl group, an ethyl group, a normal propyl group, an isopropyl group, a normal butyl group, an isobutyl group, a normal pentyl group, and a neopentyl group. Preferably, E² and E³ are each a methyl group and an isobutyl group, b is from 2 to 40, and c is from 1 to 40.

The aluminoxane described above is produced by various methods. The method is not particularly limited, a publicly known method may be used. For example, a method of bringing a solution of trialkyl aluminum (e.g., trimethyl aluminum) dissolved in an appropriate organic solvent (benzene, an aliphatic hydrocarbon, or the like) into contact with water; and a method of bringing trialkyl aluminum (e.g., trimethyl aluminum) into contact with a metal salt containing crystal water (e.g., a copper sulfate hydrate) may be exemplified.

Any one of the boron compound (C1) represented by the formula: BQ¹Q²Q³; the boron compound (C2) represented by the formula: Z÷(BQ¹Q²Q³Q⁴)⁻; and the boron compound (C3) represented by the formula: (L-H)+(BQ¹Q²Q³Q⁴)⁻ is used as the compound (C).

In the boron compound (C1) represented by the formula: BQ¹Q²Q³, B is a boron atom having a valence of three; and Q¹ to Q³ are each a halogen atom, a hydrocarbon group having 1 to 20 carbon atoms, a halogenated hydrocarbon group having 1 to 20 carbon atoms, a silyl group which is substituted by a hydrocarbon having 1 to 20 carbon atoms, an alkoxy group having 1 to 20 carbon atoms, or an amino group which is disubstituted by hydrocarbons each having 2 to 20 carbon atoms, and they may be the same or different. Preferable Q¹ to Q³ are each a halogen atom, a hydrocarbon group having 1 to 20 carbon atoms, and a halogenated hydrocarbon group having 1 to 20 carbon atoms.

Concrete examples of the boron compound (C1) include tris(pentafluorophenyl)borane, tris(2,3,5,6-tetrafluorophenyl)borane, tris(2,3,4,5-tetrafluorophenyl)borane, tris(3,4,5-trifluorophenyl)borane, tris(2,3,4-trifluorophenyl)borane, and phenylbis(pentafluorophenyl)borane; and the most preferable one is tris(pentafluorophenyl)borane.

In the boron compound (C2) represented by the formula: Z⁺(BQ¹Q²Q³Q⁴)⁻, Z⁺ is an inorganic or organic cation; B is a boron atom having a valence of three; and Q¹ to Q⁴ are the same as Q¹ to Q³ of the compound (C1).

As for concrete examples of the compound represented by the formula: Z⁺ (BQ¹Q²Q³Q⁴)⁻, when Z⁺ is an inorganic cation, Z⁺ may be a ferrocenium cation, an alkyl-substituted ferrocenium cation, a silver cation, or the like; and when Z⁺ is an organic cation, Z⁺ may be a triphenyl methyl cation, or the like.

Examples of (BQ¹Q²Q³Q⁴)⁻ include tetrakis(pentafluorophenyl)borate, tetrakis(2,3,5,6-tetrafluorophenyl)borate, tetrakis(2,3,4,5-tetrafluorophenyl)borate, tetrakis(3,4,5-trifluorophenyl)borate, tetrakis(2,2,4-trifluorophenyl)borate, phenylbis(pentafluorophenyl)borate, and tetrakis(3,5-bistrifluoromethylphenyl)borate.

Concrete examples of combinations of these include ferrocenium tetrakis(pentafluorophenyl)borate, 1,1′-dimethyl ferrocenium tetrakis(pentafluorophenyl)borate, silver tetrakis(pentafluorophenyl)borate, triphenyl methyl tetrakis(pentafluorophenyl)borate, and triphenyl methyl tetrakis(3,5-bistrifluoromethylphenyl)borate; and the most preferable one is triphenyl methyl tetrakis(pentafluorophenyl)borate.

In the boron compound (C3) represented by the formula: (L−H)+(BQ¹Q²Q³Q⁴)⁻, L is a neutral Lewis base; (L−H)⁺ is Broensted acid; B is a boron atom having a valence of three; Q¹ to Q⁴ are the same as Q¹ to Q³ in the compound (B1).

As for concrete examples of the compound represented by the formula: (L−H)⁺(BQ¹Q²Q³Q⁴)⁻, (L−H)⁺, which is Broensted acid, may be trialkyl-substituted ammonium, N,N-dialkyl anilinium, dialkyl ammonium, triaryl phosphonium, or the like; and (BQ¹Q²Q³Q⁴)⁻ may be the same as described above.

Concrete examples of combinations of these include triethyl ammonium tetrakis(pentafluorophenyl)borate, tripropyl ammonium tetrakis(pentafluorophenyl)borate, tri(normal butyl)ammonium tetrakis(pentafluorophenyl)borate, tri(normal butyl)ammonium tetrakis(3,5-bistrifluoromethylphenyl)borate, N,N-dimethyl anilinium tetrakis(pentafluorophenyl)borate, N,N-diethyl anilinium tetrakis(pentafluorophenyl)borate, N,N-2,4,6-pentamethyl anilinium tetrakis(pentafluorophenyl)borate, N,N-dimethyl anilinium tetrakis(3,5-bistrifluoromethylphenyl)borate, diisopropyl ammonium tetrakis(pentafluorophenyl)borate, dichlorohexyl ammonium tetrakis(pentafluorophenyl)borate, triphenyl phosphonium tetrakis(pentafluorophenyl)borate, tri(methylphenyl)phosphonium tetrakis(pentafluorophenyl)borate, and tri(dimethylphenyl)phosphonium tetrakis(pentafluorophenyl)borate. Of these, the most preferable one is tri(normal butyl)ammonium tetrakis(pentafluorophenyl)borate or N,N-dimethyl anilinium tetrakis(pentafluorophenyl)borate.

Although the transition metal complex (1) and the compound (B), and further the compound (C) may be added in an arbitrary order upon polymerization, the arbitrary combination of these compounds may be previously contacted with each other and the resulting reaction product may be used.

As for the amount of each catalyst used, the molar ratio of the compound (B)/the transition metal complex (1) is within the range of preferably 0.1 to 10,000, more preferably 5 to 2,000, and the molar ratio of the compound (C)/the transition metal complex (1) is within the range of preferably 0.01 to 100, more preferably 0.5 to 10.

As for the concentration of each catalyst component when it is used in the state of a solution, the concentration of the transition metal complex (1) represented by the formula (1) is within the range of preferably 0.0001 to 5 mmol/L, more preferably 0.001 to 1 mmol/L; the concentration of the compound (B) is within the range of preferably 0.01 to 500 mmol/L, more preferably 0.1 to 100 mmol/L in terms of A1 atoms; and the concentration of the compound (C) is within the range of preferably 0.0001 to 5 mmol/L, more preferably 0.001 to 1 mmol/L.

The resin composition of the present invention may be blended with an olefin-based polymer other than the component (A) and the component (B) as occasion demands, but it is preferable not to blend the olefin-based polymer.

Examples of the additional olefin-based polymer include an ethylene-based polymer.

Examples of the ethylene-based polymer include an ethylene homopolymer, a copolymer of ethylene and propylene, a copolymer of ethylene and an α-olefin having 4 to 20 carbon atoms, an ethylene-vinyl acetate copolymer, an ethylene-ethyl acrylate copolymer, and an ethylene-methacrylic acid copolymer.

These ethylene-based polymers alone may be blended with the resin composition of the present invention, or at least two kinds thereof may be blended with the resin composition of the present invention.

Examples of the ethylene homopolymer include a low density polyethylene, a medium density polyethylene, and a high density polyethylene.

Examples of the copolymer of ethylene and an α-olefin having 4 to 20 carbon atoms include an ethylene-1-butene copolymer, an ethylene-1-pentene copolymer, an ethylene-1-hexene copolymer, and an ethylene-1-octene copolymer.

To the resin composition of the present invention may be added publicly known additives such as a heat stabilizer, an ultraviolet light stabilizer, an anti-oxidant, a crystal nucleating agent, a lubricant, an anti-blocking agent, an antistatic agent, an anti-fog agent, a flame retardant, a petroleum resin, a blowing agent, a blowing aid, or an organic or inorganic filler, as occasion demands, as far as the effects of the present invention are not impaired. It goes without saying that these additives are not included in the total amount of the component (A) and the component (B), which is 100% by weight.

The method for producing the resin composition of the present invention is not particularly limited, and a publicly known method may be used.

A preferable method for producing the resin composition of the present invention is a production method including the steps of performing polymerization in the presence of the catalyst containing, as a catalyst component, the transition metal complex represented by the formula (1) to give an amorphous polybutene-based resin having a weight average molecular weight of 10,000 or more; and mixing at least the amorphous polybutene-based resin having a weight average molecular weight of 10,000 or more with a crystalline polypropylene-based resin.

In order to produce the amorphous polybutene-based resin having a weight average molecular weight of 10,000 or more, the catalyst containing, as a catalyst component, the transition metal complex represented by the formula (1), can be suitably used.

The polymerization process used in the polymerization step is not particularly limited so long as the polymerization is performed using the catalyst containing the transition metal complex represented by the formula (1) as a catalyst component. For example, solvent polymerization using, as a solvent, an aliphatic hydrocarbon such as butane, pentane, hexane, heptane or octane, an aromatic hydrocarbon such as benzene or toluene, or a halogenated hydrocarbon such as methylene dichloride, slurry polymerization, bulk polymerization, gas-phase polymerization which is performed in gaseous monomers or the like can be used, and either continuous polymerization or batch polymerization may be used.

The polymerization temperature in the polymerization step can be from −50° C. to 200° C., and the temperature range of about −20° C. to about 100° C. is particularly preferable. The polymerization pressure is preferably from an ordinary pressure to 6 MPa (60 kg/cm²G). In general, the polymerization time is appropriately selected according to the kind of the desired polymer or the reaction apparatus, and it can be from 1 minute to 20 hours. In order to control the molecular weight of the resin to be obtained, a chain transfer agent such as hydrogen may be added.

The mixing means in the mixing step is not particularly limited, and a method conventionally used in the production of the resin composition, such as a method of melt-kneading the resin mixture with heating using a kneading machine or an extruder, can be exemplified. Examples of the kneading machine include a kneader, a Banbury mixer, and a roll; and examples of the extruder include a single screw extruder and a twin screw extruder.

When the resin composition of the present invention is produced by melt-kneading with heating, the melt-kneading temperature is preferably from 150 to 300° C., more preferably from 170 to 270° C., even more preferably from 180 to 250° C.

The following molding methods can be preferably applied to the production of the resin composition of the present invention. That is, an extrusion molding method, an injection method, a compression molding method, a foam molding method, a hollow molding method, a blow molding method, a vacuum molding method, a powder molding method, a calendar molding method, an inflation method, a press molding method, and the like can be used.

Examples of the molded article obtained from the resin composition of the present invention include wrapping films, soft sheets, foamed sheets, hollow containers, fibers such as non-woven fabrics, and automobile parts including interior materials.

The resin composition of the present invention can also be preferably used as a pressure-sensitive adhesive for a pressure-sensitive adhesive film as one of the molded articles thereof. The pressure-sensitive adhesive film may be a single-sided pressure-sensitive adhesive film in which a pressure-sensitive adhesive layer is provided on one side of a substrate, or a double-sided pressure-sensitive adhesive film in which pressure-sensitive adhesive layers are provided on both sides of a substrate. A release film or release paper may be place on the pressure-sensitive adhesive layer side. In the case of a single-sided pressure-sensitive adhesive film which does not include a release film or release paper, it is preferable that release coating be applied to the layer opposite to the pressure-sensitive adhesive layer, or a material having good releasability be used. Examples of the material having good releasability include a high density polyethylene and a polyamide.

It is possible to process separately a substrate film, a pressure-sensitive adhesive layer and a release layer, and then bonding them by heating and/or pressure-bonding; however, it is preferable to simultaneously process a plurality of layers by co-extrusion or lamination because the number of steps can be reduced. For example, a substrate and a pressure-sensitive adhesive layer may be co-extruded onto release paper, whereby a single-sided pressure-sensitive adhesive tape can be produced in one step.

The thus obtained pressure-sensitive adhesive film is preferably used in fields such as electronics fields, for example, as a back grind tape for semiconductor wafers, a tape for fixing an abrasive cloth, a dicing tape, a protective tape for carrying electronic parts, and a protective tape for printed boards; automobile fields, for example, as a protective film for windowpane, a film for baking finish, a guard film used for protecting a car until it is delivered to a user, a marking film for display, a marking film for decoration, and a sponge tape for buffering, protection, heat insulation or sound insulation; medical and hygienic material fields, for example, as a patch or a transdermal absorption patch; optical fields in which protection of a retardation plate is required; and residential and building material fields, for example, as a pressure-sensitive adhesive film or protective film for electric insulation, distinction, duct-working, windowpane protection, curing, wrapping, packaging, business applications, household applications, fixing, binding, and mending.

### EXAMPLES

In the following, the present invention will be explained in more detail by way of examples, but the present invention is not limited thereto.

### 1. Weight Average Molecular Weight (Mw) and Molecular Weight Distribution (Mw/Mn)

The weight average molecular weight (Mw) and the molecular weight distribution (Mw/Mn) were measured by gel permeation chromatography (GPC) using a monodisperse polystyrene as a standard sample.

As a measuring apparatus, 150C/GPC manufactured by Waters was used. The elution temperature was set at 140° C., Sodex Packed Columns A-80M (two) manufactured by Showa Denko K. K. were used as columns, and a polystyrene having a molecular weight of 68 to 8,400,000 manufactured by Tosoh Corporation was used as a molecular weight standard.

From the obtained weight average molecular weight (Mw) and number average molecular weight (Mn) in terms of a polystyrene, the ratio thereof (Mw/Mn) was calculated as the molecular weight distribution.

A measurement sample having a concentration of about 1 mg/ml was produced by dissolving about 5 mg of a polymer in 5 ml of o-dichlorobenzene. Of the obtained sample solution, 400 μl was injected. The flow rate of the elution solvent was 1.0 ml/minute, and the detection was performed using a refractive index detector.

### 2. Amount of Heat of Crystal Fusion

The amount of heat of crystal fusion was measured by differential scanning calorimetry (DSC). The amount of heat of crystal fusion was obtained by using a differential scanning calorimeter, for example, DSC 220 C manufactured by Seiko Instruments Inc. under the following conditions. That is, the temperature of about 10 mg of a sample was elevated from room temperature to 200° C. at a rate of temperature increase of 30° C./minute, and the sample was kept for 5 minutes after the completion of temperature increase. Then, the temperature was decreased from 200° C. to −100° C. at a rate of temperature decrease of 10° C./minute, and was kept for 5 minutes after the completion of temperature decrease. After that, the temperature was elevated from −100° C. to 200° C. at a rate of temperature increase of 10° C./minute, and the amount of heat of crystal fusion was obtained from the peak area which was observed during this temperature increase.

### 3. Degree of Crystallization (Xc)

The degree of crystallization (Xc) was measured using an X-ray diffractometer (trade name Ultra-X-18 manufactured by Rigaku Corporation). A 100-μm-thick sheet, which had been obtained by press molding at 190° C., was used for the measurement. The cooling temperature after press molding was set at 30° C.

4. Content of Monomer Units Derived from Ethylene and α-Olefin (Unit: mol %)

The content of monomer units derived from ethylene and an α-olefin in a polypropylene-based resin or a polybutene-based resin was calculated based on measurement results of ¹H NMR spectra and ¹³C NMR spectra using a nuclear magnetic resonance apparatus (trade name AC-250 manufactured by Bruker). Specifically, the composition ratio of propylene and 1-butene was calculated from the ratio of the spectral intensity of methyl carbon derived from propylene and the spectral intensity of methyl carbon derived from 1-butene of ¹³C NMR spectra, and then the composition ratio of ethylene, propylene and 1-butene was calculated from the ratio of the spectral intensity of hydrogen derived from methine+methylene and the spectral intensity of hydrogen derived from methyl of ¹H NMR spectra.

5. Half Crystallization Time (t_{1/2}, Unit: Second)

As an indicator of processability of a resin composition, the half crystallization time (t_{1/2}) showing the crystallization rate was measured using a depolarization method. The depolarization method is a method in which a sample is placed between two polarization plates which are orthogonal to each other, molten and then crystallized at a certain temperature. According to the method, the process of crystallization is followed using the transmitted light volume. The longer the half crystallization time, the slower the crystallization, and therefore such a composition has good processability because the range of conditions suitable for processing is widened.

The sample was molten in an air bath set at 230° C. for 10 minutes. Crystallization was performed in an oil bath set at 135° C. Here, the system was made such that the center of the sample was placed in a light path of a light source for measurement.

The value t_{1/2} was calculated from the difference in transmitted light volume between the molten state (just after the sample was moved to the oil bath) and the completely crystallized state. The time at which the sample was moved to the oil bath of 135° C. is defined as t=0, and the period of time during which the light volume was changed by a half of the difference in transmitted light volume is defined as the half crystallization time. The longer the half crystallization time, the slower the crystallization.

### 6. Appearance of Press Sheet

The transparency of the molded article was visually evaluated about the exterior appearance of a 100-μm-thick press sheet, which had been produced by press molding a resin composition in accordance with JIS-K-6758. Specifically, the press sheet was put on a printed material, and sharpness of letters on the printed material which were seen through the press sheet was evaluated by the following criteria.

Good: Letters can be clearly read
Acceptable: Profiles of letters are unclear
Poor: Whole letters are unclear

### Example 1

### Polymerization

To a 300 ml autoclave was added 1-butene (80 g), and was stabilized at 40° C., and 0.05 MPa ethylene overpressure was applied thereto. Triisobutyl aluminum (a toluene solution, 100 μmol), diethylsilyl(2,7-diphenylfluorenyl)(3-tert-butyl-5-methyl-2-phenoxy)titanium dichloride (a toluene solution, 0.1 μmol), and N,N-dimethyl anilinium tetrakis(pentafluorophenyl)borate (a toluene solution, 0.6 μmol) were added thereto, and the mixture was polymerized at 40° C. for 10 minutes.

As a result of the polymerization, a polymer was produced in an amount of 37.4×10⁷ g/mol of titanium/hour. Properties of the obtained polymer 2 are shown in Table 1. According to the DSC, neither a crystal fusion peak in which the amount of heat of crystal fusion is 1 J/g or more nor a crystallization peak in which the amount of heat of crystallization is 1 J/g or more was observed in a range of −100 to 200° C.

### <Mixing>

As the component A, Noblene FLX 80E4 (polymer 1) manufactured by Sumitomo Chemical Co., Ltd. was used, and as the component B, the polymer 2 described above was used. The component A and the component B were mixed by a xylene dissolution method. Into a round-bottom flask were added 2.25 g of the polymer 1, 0.25 g of the polymer 2, and 80 g of xylene, and the contents were refluxed in an oil bath at a temperature range of 135 to 140° C. for 1.5 hours. The resulting uniform xylene solution was added dropwise to about 800 ml of methanol. Vacuum-drying at 100° C. for 1 day gave a resin composition (solid).

The polymer 1 used was Noblene FLX 80E4 manufactured by Sumitomo Chemical Co., Ltd., and the properties thereof are as shown in Table 1.

### <Press>

Press molding was performed using the obtained resin composition in accordance with JIS-K-6758, thereby obtaining a 100-μm-thick sheet. Evaluation results of the sheet are shown in Table 2.

### Example 2

### Mixing

A resin composition (solid) was obtained in the same manner as in Example 1, except that 1.75 g of the polymer 1 and 0.75 g of the polymer 2 were used.

### <Press>

A 100-μm-thick sheet was obtained in the same manner as in Example 1 using the obtained resin composition.

Evaluation results of the sheet are shown in Table 2.

### Example 3

### Polymerization

To an autoclave was added 5.0 ml of toluene under nitrogen, which was stabilized at 40° C., and then 1-butene was introduced thereto. The mixture was pressurized to 0.10 MPa and stabilized. Triisobutyl aluminum (a toluene solution, 40 μmol), diethylsilylene[2,7-di(4-n-butylphenyl)fluorene-9-yl](3-tert-butyl-5-methyl-2-phenoxy)titanium dichloride (a toluene solution, 0.1 μmol, and N,N-dimethyl anilinium tetrakis(pentafluorophenyl)borate (a toluene solution, 0.3 μmol) were added thereto, and the mixture was polymerized at 40° C. for 11 minutes.

As a result of the polymerization, a polymer was produced in an amount of 2.27×10⁷ g/mol of titanium/hour. Properties of the obtained polymer 3 are shown in Table 1. According to the DSC, neither a crystal fusion peak in which the amount of heat of crystal fusion is 1 J/g or more nor a crystallization peak in which the amount of heat of crystallization is 1 J/g or more was observed in a range of −100 to 200° C.

### <Mixing>

A resin composition (solid) was obtained in the same manner as in Example 1 except that 1.8 g of the polymer 1, 0.2 g of the polymer 3 instead of the polymer 2, and 65 g of xylene were used.

### <Press>

A 100-μm-thick sheet was obtained in the same manner as in Example 1 using the obtained resin composition.

Evaluation results of the sheet are shown in Table 2.

### Example 4

### Polymerization

To a 300 ml autoclave was added 1-butene (80 g), which was stabilized at 40° C., and 0.10 MPa ethylene overpressure was applied thereto. Triisobutyl aluminum (a toluene solution, 100 μmol), diethylsilyl(2,7-diphenylfluorenyl)(3-tert-butyl-5-methyl-2-phenoxy)titanium dichloride (a toluene solution, 0.03 μmol), and N,N-dimethyl anilinium tetrakis(pentafluorophenyl)borate (a toluene solution, 0.6 μmol) were added thereto, and the mixture was polymerized at 40° C. for 10 minutes.

As a result of the polymerization, a polymer was produced in an amount of 21.4×10⁷ g/mol of titanium/hour. Properties of the obtained polymer 4 are shown in Table 1. According to the DSC, neither a crystal fusion peak in which the amount of heat of crystal fusion is 1 J/g or more nor a crystallization peak in which the amount of heat of crystallization is 1 J/g or more was observed in a range of −100 to 200° C.

### <Mixing>

A resin composition (solid) was obtained in the same manner as in Example 1 except that 0.72 g of the polymer 1, 0.18 g of the polymer 4 instead of the polymer 2, and 29 g of xylene were used.

### <Press>

A 100-μm-thick sheet was obtained in the same manner as in Example 1 using the obtained resin composition.

Evaluation results of the sheet are shown in Table 2.

### Comparative Example 1

Under the same conditions as in Example 1, 2.5 g of the polymer 1 was dissolved in xylene without using the component (B). A 100-μm-thick sheet was obtained using the obtained polymer 1 in the same manner as in Example 1. Evaluation results of the sheet are shown in Table 2. When the appearance of the sheet was visually evaluated, the transparency was lower than that in Examples 1 to 4.

### Comparative Example 2

### Mixing

A resin composition (solid) was obtained in the same manner as in Example 1 except that 1.75 g of the polymer 1, and 0.75 g of the polymer 5 instead of the polymer 2 were used.

The polymer 5 used was UT 2780 (APAO) manufactured by Ube Rekisen, and properties thereof are shown in Table 1.

### <Press>

A 100-μm-thick sheet was obtained in the same manner as in Example 1 using the obtained resin composition.

Evaluation results of the sheet are shown in Table 2. On the sheet, whitening due to bleeding was observed with the passage of time.

### Comparative Example 3

### Polymerization

To a 100 L SUS polymerization vessel equipped with a stirrer were continuously supplied, from the bottom of the polymerization vessel, hexane as a polymerization solvent at a supply rate of 100 L/hour, propylene at a supply rate of 24.00 kg/hour, and 1-butene at a supply rate of 1.81 kg/hour. Using hydrogen for a molecular weight modifier, co-polymerization was continuously performed in the following manner to give a propylene-1-butene copolymer.

From the bottom of the polymerization vessel, dimethylsilylene(tetramethylcyclopentadienyl)(3-tert-butyl-5-methyl-2-phen oxy)titanium dichloride was continuously supplied at a supply rate of 0.005 g/hour, triphenyl methyl tetrakis(pentafluorophenyl)borate was continuously supplied at a supply rate of 0.298 g/hour, and triisobutyl aluminum was continuously supplied at a supply rate of 2.315 g/hour, as polymerization catalyst components.

The co-polymerization reaction was performed at 45° C. by circulating cooling water in a jacket equipped to the outside of the polymerization vessel.

The reaction mixture was continuously taken out from the upper part of the polymerization vessel so that the amount of the reaction mixture in the polymerization vessel was kept at 100 L. After a small amount of ethanol was added to the reaction mixture which was continuously taken out to stop the polymerization reaction, monomers were removed therefrom, and the resulting mixture was washed with water. Then, the solvent was removed therefrom by steam in a massive amount of water to give a propylene-1-butene copolymer, which was dried under reduced pressure at 80° C. for all night and all day.

Properties of the obtained polymer 6 are shown in Table 1. According to the DSC, neither a crystal fusion peak in which the amount of heat of crystal fusion is 1 J/g or more nor a crystallization peak in which the amount of heat of crystallization is 1 J/g or more was observed in a range of −100 to 200° C.

### <Mixing>

A resin composition (solid) was obtained in the same manner as in Example 1 except that 1.75 g of the polymer 1 and 0.75 g of the polymer 6 instead of the polymer 2 were used.

### <Press>

A 100-μm-thick sheet was obtained in the same manner as in Example 1 using the obtained resin composition. Evaluation results of the sheet are shown in Table 2. When the appearance of the sheet was visually observed, the transparency was lower than in Examples 1 to 4.

TABLE 1

| | | Polymer 1 | Polymer 2 | Polymer 3 | Polymer 4 | Polymer 5 | Polymer 6 |
|---|---|---|---|---|---|---|---|
| Monomer | Ethylene | 0 | 4 | 0 | 6 | 0 | 0 |
| Composition | Propylene | 100 | 0 | 0 | 0 | 62 | 96 |
| [mol %] | 1-Butene | 0 | 96 | 100 | 94 | 38 | 4 |

| | | | | | | |
|---|---|---|---|---|---|---|
| Mw | 423,000 | 535,000 | 280,000 | 795,000 | 83,000 | 574,000 |
| Mw/Mn | 4.3 | 1.5 | 1.9 | 1.5 | 9.2 | 1.9 |
| Melting Point (Tm) [° C.] | 162 | Not | Not | Not | 93 | Not |
| | | detected | detected | detected | | detected |
| Amount of Heat of | 111 | 0 | 0 | 0 | 5 | 0 |
| Fusion [J/g] | | | | | | |
| Crystallization | 114 | Not | Not | Not | 57 | Not |
| Temperature (Tc) [° C.] | | detected | detected | detected | | detected |
| Degree of Crystallization | 53 | 0 | 0 | 0 | 15 | 0 |
| (Xc) [%] | | | | | | |

TABLE 2

| | | Example | Example | Example | Example | Comparative | Comparative | Comparative |
|---|---|---|---|---|---|---|---|---|
| | | 1 | 2 | 3 | 4 | Example 1 | Example 2 | Example 3 |
| Component | Polymer 1 | 90 | 70 | 90 | 80 | 100 | 70 | 70 |
| A [wt %] | | | | | | | | |
| Component | Polymer 2 | 10 | 30 | | | | | |
| B [wt %] | Polymer 3 | | | 10 | | | | |
| | Polymer 4 | | | | 20 | | | |
| | Polymer 5 | | | | | | 30 | |
| | Polymer 6 | | | | | | | 30 |

| | | | | | | | |
|---|---|---|---|---|---|---|---|
| Half Crystallization | 1,480 | 1,860 | 2,215 | 1,711 | 1,050 | 1,160 | 1,320 |
| Time t_{1/2} [sec] | | | | | | | |
| Appearance of Press | Good | Good | Good | Good | Acceptable | Poor | Acceptable |
| Sheet | | | | | | | |

1. A resin composition comprising:
1 to 99% by weight of the following component (A), and
99 to 1% by weight of the following component (B), wherein the total amount of the component (A) and the component (B) is 100% by weight:
(A) a crystalline polypropylene-based resin; and
(B) an amorphous polybutene-based resin having a weight average molecular weight of 10,000 or more, wherein neither a crystal fusion peak in which the amount of heat of crystal fusion is 1 J/g or more nor a crystallization peak in which the amount of heat of crystallization is 1 J/g or more is observed within a range of −100 to 200° C. as measured by differential scanning calorimetry (DSC).

2. The resin composition according to claim 1, wherein the component (B) has a molecular weight distribution of 1 to 4.

3. The resin composition according to claim 1, wherein the component (B) has a weight average molecular weight larger than that of the component (A).

4. The resin composition according to claim 1, wherein the component (B) is a resin obtained by polymerization in the presence of a catalyst containing, as a catalyst component, a transition metal complex represented by the following formula (1): 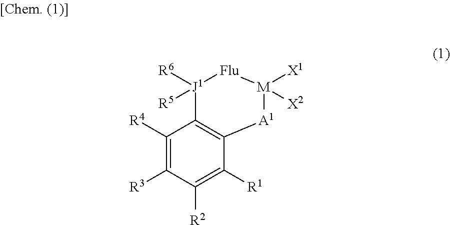
wherein M is a transition metal atom of Group 4 of the periodic table of elements; A¹ is an atom of Group 16 of the periodic table of elements; J¹ is an atom of Group 14 of the periodic table of elements; Flu is a group having a fluorenyl-type anion skeleton; X¹ and X² are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R¹, R², R³ and R⁴ are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R⁵ and R⁶ are each independently a hydrogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom or an amino group disubstituted by hydrocarbons each having 2 to 20 carbon atoms; and adjacent groups of R¹, R², R³, R⁴, R⁵ and R⁶ may be optionally bonded to form a ring.

5. The resin composition according to claim 2, wherein the component (B) has a weight average molecular weight larger than that of the component (A).

6. The resin composition according to claim 2, wherein the component (B) is a resin obtained by polymerization in the presence of a catalyst containing, as a catalyst component, a transition metal complex represented by the following formula (1): 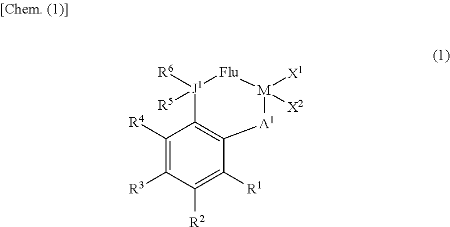
wherein M is a transition metal atom of Group 4 of the periodic table of elements; A¹ is an atom of Group 16 of the periodic table of elements; J¹ is an atom of Group 14 of the periodic table of elements; Flu is a group having a fluorenyl-type anion skeleton; X¹ and X² are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R¹, R², R³ and R⁴ are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R⁵ and R⁶ are each independently a hydrogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom or an amino group disubstituted by hydrocarbons each having 2 to 20 carbon atoms; and adjacent groups of R¹, R², R³, R⁴, R⁵ and R⁶ may be optionally bonded to form a ring.

7. The resin composition according to claim 3, wherein the component (B) is a resin obtained by polymerization in the presence of a catalyst containing, as a catalyst component, a transition metal complex represented by the following formula (1): 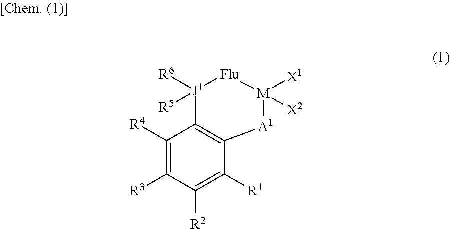
wherein M is a transition metal atom of Group 4 of the periodic table of elements; A¹ is an atom of Group 16 of the periodic table of elements; J¹ is an atom of Group 14 of the periodic table of elements; Flu is a group having a fluorenyl-type anion skeleton; X¹ and X² are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R¹, R², R³ and R⁴ are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R⁵ and R⁶ are each independently a hydrogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom or an amino group disubstituted by hydrocarbons each having 2 to 20 carbon atoms; and adjacent groups of R¹, R², R³, R⁴, R⁵ and R⁶ may be optionally bonded to form a ring.

8. The resin composition according to claim 5, wherein the component (B) is a resin obtained by polymerization in the presence of a catalyst containing, as a catalyst component, a transition metal complex represented by the following formula (1): 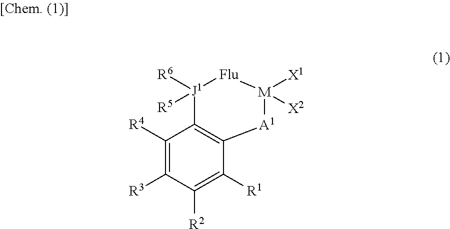
wherein M is a transition metal atom of Group 4 of the periodic table of elements; A¹ is an atom of Group 16 of the periodic table of elements; J¹ is an atom of Group 14 of the periodic table of elements; Flu is a group having a fluorenyl-type anion skeleton; X¹ and X² are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R¹, R², R³ and R⁴ are each independently a hydrogen atom, a halogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom, or an amino group disubstituted by hydrocarbons each having 2 to 20 carbon atoms; R⁵ and R⁶ are each independently a hydrogen atom, an alkyl group having 1 to 20 carbon atoms which may be substituted by a halogen atom, an aralkyl group having 7 to 20 carbon atoms which may be substituted by a halogen atom, an aryl group having 6 to 20 carbon atoms which may be substituted by a halogen atom, a silyl group substituted by a hydrocarbon having 1 to 20 carbon atoms which may be substituted by a halogen atom, an alkoxy group having 1 to 20 carbon atoms which may be substituted by a halogen atom, an aralkyloxy group having 7 to 20 carbon atoms which may be substituted by a halogen atom, an aryloxy group having 6 to 20 carbon atoms which may be substituted by a halogen atom or an amino group disubstituted by hydrocarbons each having 2 to 20 carbon atoms; and adjacent groups of R¹, R², R³, R⁴, R⁵ and R⁶ may be optionally bonded to form a ring.
